(19) United States
(12) Patent Application Publication
(10) Pub. No.: US 2004/0197181 A1
(43) Pub. Date: Oct. 7, 2004

(54) Mobile load handling apparatus

(76) Inventor: Curtis C. Clark, Spokane, WA (US)

Correspondence Address: KLARQUIST SPARKMAN, LLP, 121 SW SALMON STREET, SUITE 1600, PORTLAND, OR, 97204, US

(21) Appl. No.: 10/485,706

(22) PCT Filed: Aug. 2, 2002
(86) PCT No.: PCT/US02/24542

Related U.S. Application Data
(60) Provisional application No. 60/310,164, filed on Aug. 3, 2001.

(51) Int. Cl. B66C 1/00

(52) U.S. Cl. 414/729; 280/762

(57) ABSTRACT

Load manipulating mechanism is mounted on a mobile wheel-driven support platform. All driving mechanism, energy source, and needed functional apparatus for mobility and lifting are self contained on the apparatus such that it may be conveniently moved to needed work sites for lifting and materials manipulation. Outriggers extendible from the main support platform and having surface engaging pads provide stability and leveling. Load arms in the mechanism are extendible and retractable between stowed travel and extended operating conditions, and include telescopic sections in a parallelogram arrangement. The load manipulating mechanism functions as load balancer, using a pneumatic control system and counterweight.

Applicants claim the benefit of the earlier filing date of U.S. Provisional Application Serial No. 60/310,164 filed Aug. 3, 2001. The entire disclosure of provisional application No. 60/310,164 is to be considered part of the disclosure of this application and is incorporated herein by reference.

### FIELD OF THE INVENTION

This invention relates generally to load handling apparatus, and more particularly to self-contained mobile load handling apparatus.

### BACKGROUND

In mining, construction, and other industries often there are materials to be lifted, manipulated, and moved. In such environments the space within which one can work may be constricted and it may be inconvenient to move previously known lifting equipment to the needed site. In such instances, workmen may try to handle the material manually although its weight is such that they should employ lifting equipment. This may result in injury to the workers.

Previously known load handling apparatus which may be used in confined environments often have had limitations, such as lack of mobility, insufficient stability and leveling capabilities, and physical size which made it inconvenient to move such from one work area to another.

In regard to mobility, prior devices often have been mounted on bases which are merely set on an underlying work surface, and ancillary moving equipment is required to lift the apparatus and move it to a different location.

As to stability and leveling, prior devices often have failed to provide mechanism for leveling on uneven underlying surfaces. This is particularly important in environments, such as in mining, construction and other sites, where there may be substantial unevenness in the underlying surface, yet where maximum stability and leveling is important due to the type of load lifting and manipulation required.

As to physical size limitations, in mining operations, construction, and other environments where space may be restricted, prior devices of sufficient lifting capacity have been too large and difficult to move from place to place, such that workers often would not take the time and effort required to move such prior devices to the work site and would attempt to do the work manually, resulting in possible injury to the workers.

In light of the number of accidents and injuries that have occurred, it has become important to provide mobile lifting apparatus which may be used in such environments.

### SUMMARY OF THE DISCLOSURE

An aspect of the present disclosure is to provide mobile load handling apparatus which is self contained and operable to move conveniently into constricted work environments to provide load manipulating capability.

Yet another aspect of the disclosure is to provide load handling apparatus which has stabilizing and support elements which may be extended laterally of a support platform for the apparatus and having feet which may be lowered under power against the underlying support surface to level and stabilize the apparatus.

A still further aspect of the disclosure is the provision of such apparatus which is configured with selected maximum width and height dimensions allowing it to move into constricted working environments, while still having the capability to provide needed lifting.

Another aspect of the disclosure is to provide such apparatus which has an elongate load arm which is extensible to an operating condition and is retractable to a compact stowed condition for travel.

Yet another aspect of the disclosure is to provide self-contained lifting apparatus which has sufficient mobility and configuration that it will be convenient enough for workmen to bring to a work site, such that it will be used as needed to alleviate lifting injuries which have occurred previously due to manual lifting and materials manipulation in the past.

In one aspect of the present disclosure, load handling apparatus is provided which has a support platform, at least one motor driven wheel supporting the platform for movement over an underlying surface, a reversible fluid-actuated driving motor operatively connected to the wheel, a source of pressurized fluid on the platform and valve mechanism for routing pressurized fluid to the driving motor, stabilizing mechanism operable to support and stabilize the platform in a selected operating position, and load manipulating mechanism mounted on the platform operable to lift a load adjacent the platform.

These and other aspects of the disclosure will become more clearly apparent as the following description is read in conjunction with the drawings.

### BRIEF DESCRIPTION OF THE DRAWINGS

FIG. 1 is a perspective view of apparatus according to one embodiment of the disclosure in operation;

FIG. 2 is a side elevation view of the apparatus of FIG. 1 with load arms of the apparatus shown in a variety of operating positions;

FIG. 3 is a side elevation view with load arms retracted to a stowed position for travel;

FIG. 4 is a simplified schematic diagram of a hydraulic drive circuit for the apparatus;

FIG. 5 is a simplified schematic diagram of an operating circuit for outrigger mechanism;

FIG. 6 is a simplified schematic circuit diagram for an operating system of a load manipulator in the apparatus;

FIG. 7 is a side elevation view of a second embodiment;

FIG. 8 is a rear perspective view of the apparatus illustrated in FIG. 7;

FIG. 9 is an enlarged side elevation view of an outrigger used in the apparatus in an extended, or deployed, state;

FIG. 10 is an enlarged side elevation view of an outrigger in a retracted, or stored, state; and

FIG. 11 is a simplified schematic diagram of an operating circuit for outrigger mechanism in the apparatus illustrated in FIGS. 7 and 8.

### DETAILED DESCRIPTION OF PREFERRED EMBODIMENT

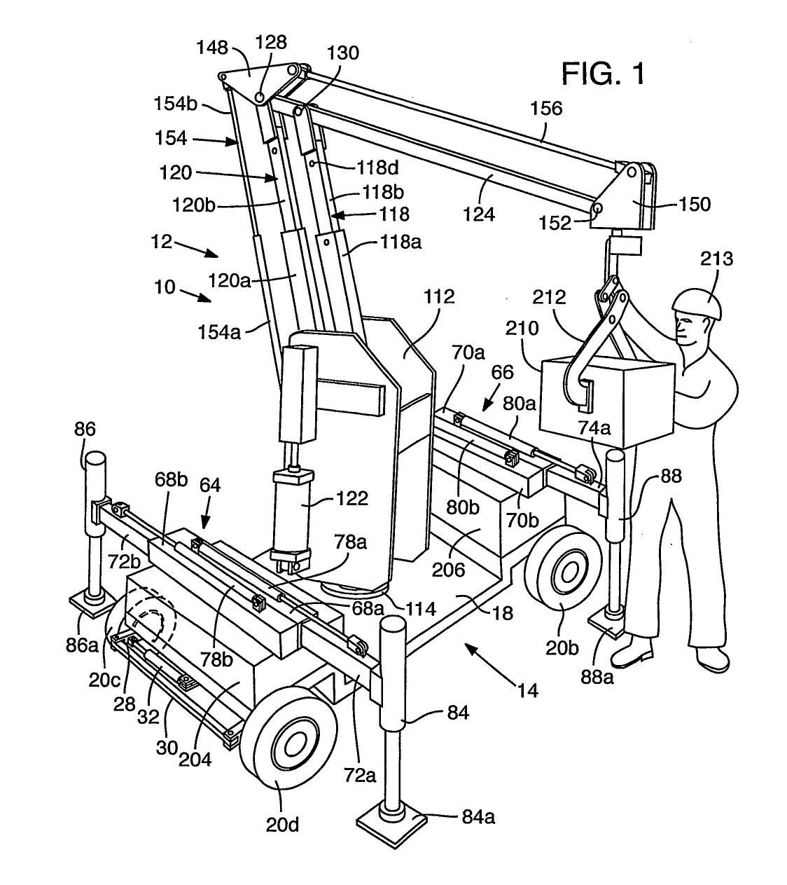

Referring to the drawings, and first more specifically to FIG. 1, at 10 is indicated generally apparatus according to an embodiment of the invention. The apparatus illustrated includes a load manipulator 12 mounted on a wheeled base 14. The apparatus is substantially self-contained, having operating mechanism for driving the wheeled-base and for supplying power for manipulator 12 mounted on base 14, as will be described in greater detail below.

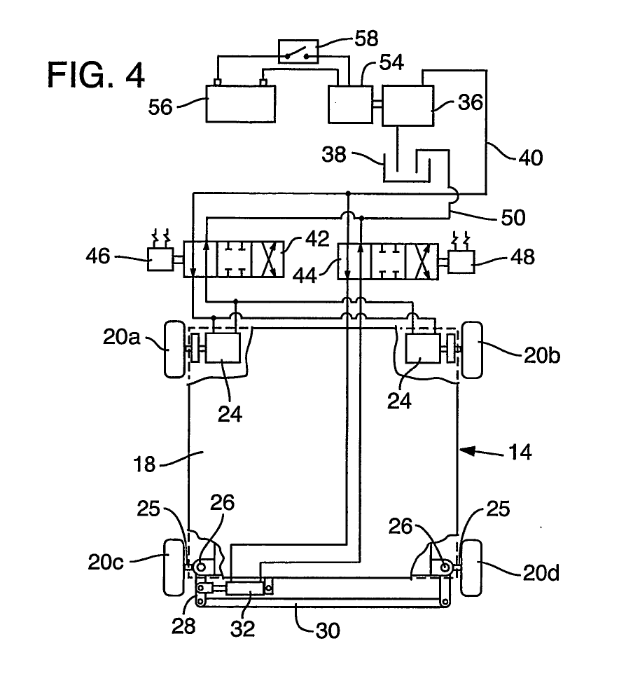

The base 14 includes a substantially horizontally disposed platform 18 with supporting wheels 20a, 20b, 20c, 20d (FIGS. 1 and 4) mounted adjacent its four corners. A wide variety of tire types may be used to suit the terrain. In some applications the wheels may have hard rubber or foam filled rubber tires thereon which do not require inflation, and thus are well adapted for use in environments where inflated tires may be difficult to maintain. In other applications pneumatic inflated tires having selected tread pattern for the environment in which used may be chosen.

Rear wheels 20a, 20b have hydraulic motors 24 (see FIG. 4) operatively connected thereto, such that operation of motors 24 serves to turn wheels 20a, 20b under power. In an alternate embodiment wheels 20a, 20b may be connected by a drive shaft turned by a single motor 24, or only a single wheel 20a may be driven by a single motor, depending upon the drive requirements for the apparatus.

The horizontally disposed axles 25 of wheels 20c, 20d are mounted on vertically disposed pivots 26 so that they may be turned to the right or left to steer the apparatus while it is being driven. Linkage arms 28 are secured to pivots 26 and extend forwardly therefrom, and are connected to each other by an elongate steering rod 30 which extends therebetween. An extensible-retractable ram 32 is connected at its rod end to one of linkage arms 28, such that extension and retraction of the ram serves to turn wheels 20c, 20d to steer mobile platform 14.

Still referring to FIG. 4, the operating system for motors 24 and ram 32 includes a hydraulic pump 36 connected at its infeed side to a fluid reservoir 38 and through an outfeed line 40 to control valves 42, 44. Each of the control valves may be a three position valve, with such being normally biased to a centered position in which hydraulic fluid is neither routed to or from its associated hydraulically operated device. Valve 42 has an actuator 46 operatively connected thereto, while valve 44 has an actuator 48 operatively connected thereto. Actuators 46, 48 are operable to shift their associated valves selectively from their normally centered positions to either of a forward running or reverse running condition. In FIG. 4 both valves are shown shifted to a similar operating condition or position. In the conditions illustrated, motors 24 would have pressurized hydraulic fluid supplied thereto from pump 36 via line 40 to drive them in a forward direction, with return fluid routed back through line 50 to reservoir 38. Similarly, with valve 44 in the position illustrated, pressurized hydraulic fluid would be routed to one end of ram 32 to retract the ram causing wheels 20c, 20d to turn to direct the mobile platform to the left.

Reverse operation of actuators 46, 48 would cause their associated valves to be moved to their second operating condition which would produce reverse operation of their associated motors and ram, respectively.

Pump 36 is operatively connected to a motor 54 which is supplied energy from an on-board battery 56, with the electrical energy supply to motor 54 being controlled by a switch 58.

Although not shown in the illustrations, appropriate control mechanism and circuitry would be provided for producing selected operation of actuators 46, 48 for driving and steering the platform.

Mounted at the front and rear of platform 14 are two sets of outrigger apparatus 64, 66, respectively. The outrigger apparatus is operable to level and stabilize the load-handling apparatus during load manipulation and lifting operations.

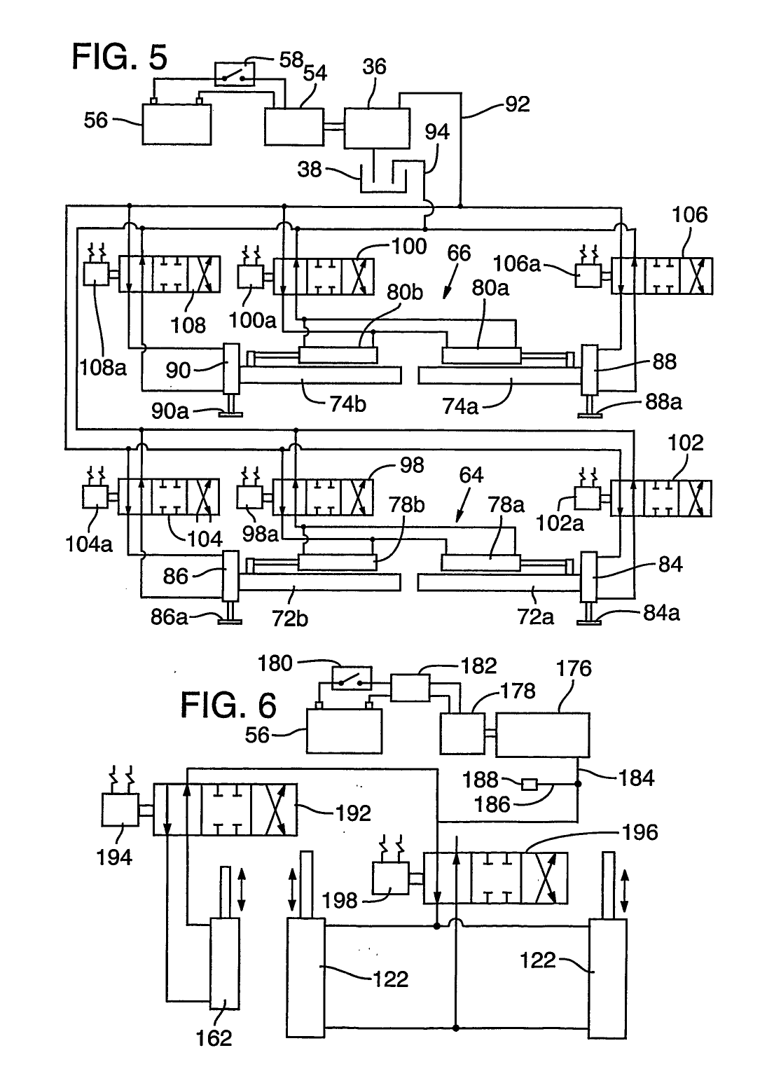

Referring to FIGS. 1 and 5, each outrigger includes a pair of parallel, horizontally disposed, hollow tubes such as those indicated at 68a, 68b for outrigger 64, and 70a, 70b for outrigger 66. Each tube has an elongate outrigger arm slidably mounted therein for extension and retraction relative to the platform. These arms are indicated generally at 72a, 72b, 74a, 74b, respectively.

Each set of outrigger arms includes a pair of diametrically opposed operating rams such as those indicated at 78a, 78b for outrigger 64, and 80a, 80b for outrigger 66. The cylinder ends of the rams are secured relative to platform 18, with their rod ends extending laterally outwardly and attached to their associated outrigger arms 72a, 72b, 74a, 74b, respectively. Extension of the rams slides their respective outrigger arms laterally outwardly in their associated guide tubes relative to platform 18 to the operating positions shown in FIG. 1. Retraction of the rams returns the outrigger arms to closely stowed positions adjacent platform 18.

Secured to the outer ends of arms 72a, 72b, 74a, 74b, respectively, are upright stabilizing rams 84, 86, 88, and 90. The stabilizing rams are vertically disposed and have downwardly depending rods to the lower ends of which are secured ground engaging pads, or feet, 84a, 86a, 88a, 90a.

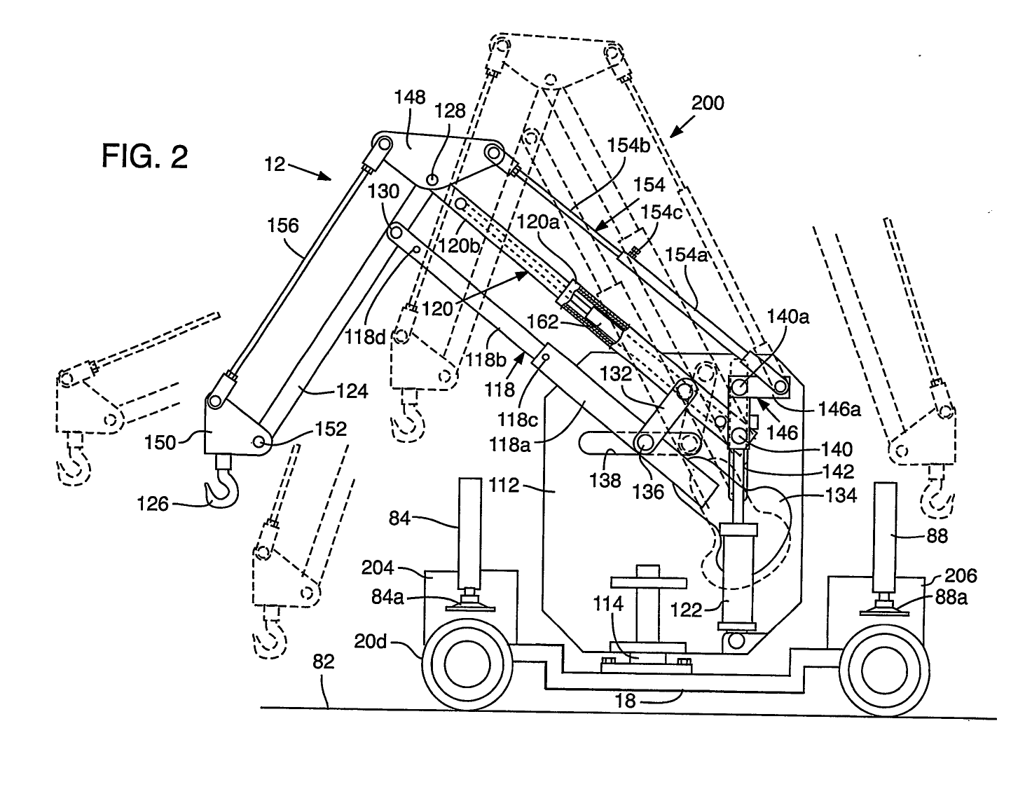

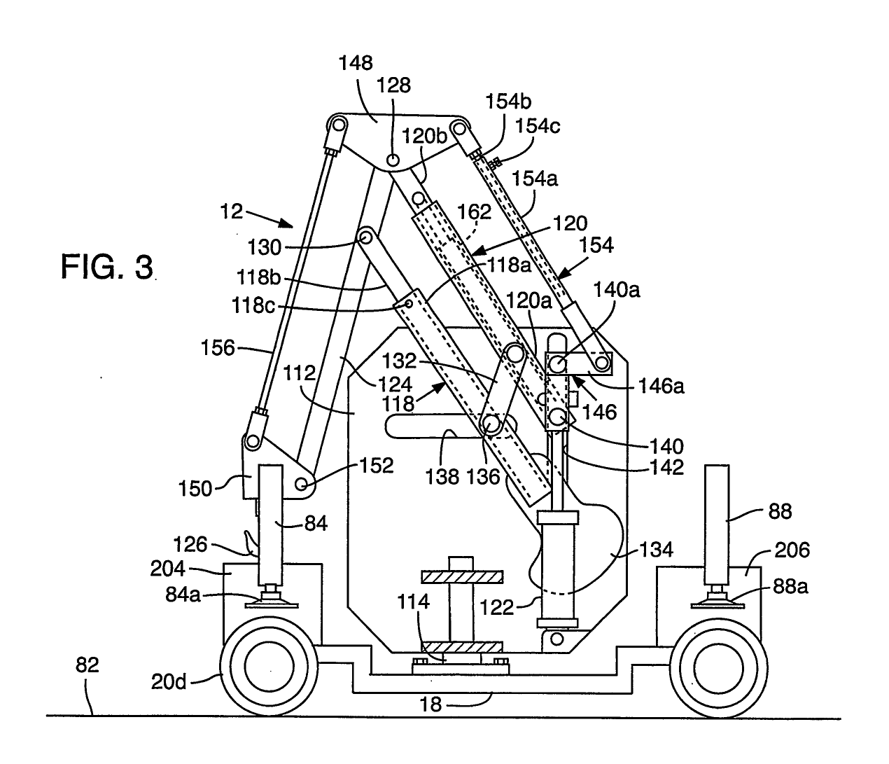

Normally the stabilizing rams are retracted for travel, as shown in FIG. 3, such that their feet are raised above the support surface 82 on which the apparatus runs. When the apparatus has been moved to the position in which it is to be used to manipulate a load, the outriggers are extended laterally from platform 18 to form a broad support pattern, and the stabilizing rams 84, 86, 88, 90 are extended sufficiently that their ground engaging feet engage the support surface 82 to stabilize the apparatus. This operating position for the outriggers is shown in FIGS. 1 and 2. Should the apparatus be on an uneven underlying surface, selected rams may be extended to a greater or lesser amount to provide leveling for the platform and its associated apparatus. To this end a bubble level (not shown) on the apparatus serves to indicate to the operator when the platform and its associated apparatus have been properly leveled.

In FIG. 5, a simplified operating schematic diagram of a hydraulic circuit for operating the outriggers is illustrated. The rams for the outriggers are given the same numbers are those associated with the parts in FIG. 1.

Pressurized hydraulic fluid for operating the outrigger system may be provided by the same system which supplied pressurized operating fluid for the drive system shown in FIG. 4. Thus, pump 36 driven by motor 54 and energized by battery 56 through a switch 58 draws operating fluid from a reservoir 38. In the system illustrated in FIG. 5 the pump delivers fluid under pressure to an outfeed line 92 and fluid is returned to the reservoir 38 through a return line 94.

Valves 98, 100, 102, 104, 106, and 108 are interposed in the hydraulic circuit between pump 36 and respective ones of the previously described rams for the outrigger system. Valve 98 is associated with rams 78a, 78b, and valve 100 is associated with rams 80a, 80b. Valve 102 is associated with ram 84, valve 104 with ram 86, valve 106 with ram 88, and valve 108 with ram 90.

All of the valves may be substantially the same, in that they are three position valves having a central position to which the valve is normally biased which shuts off flow to and from its associated ram. Each valve also is shiftable to a second position in which pressurized fluid is supplied to a first end of its associated ram and fluid is exhausted from the second end of the ram to provide extension of the ram, and a third position in which fluid is supplied to the second end of the ram and exhausted from the first end to produce retraction of the ram. Each valve has an associated actuator connected thereto noted 98a, 100a, 102a, 104a, 106a, 108a, respectively, for producing selected shifting of the valve to an appropriate position for extending, retracting, or stopping movement of its associated ram.

Each of the valves illustrated of FIG. 5 is illustrated as positioned to provide fluid under pressure from pump 36 to its associated ram to produce extension of the ram. With this organization of valves, the outrigger arms are extended by rams 78a, 78b, 80a, 80b, horizontally and laterally outwardly from platform 18 to their extended stabilizing position relative to the platform. The rod ends of the stabilizing rams 84, 86, 88, 90 are extended downwardly so that their associated ground engaging feet may press against the underlying surface 82 to level and stabilize the platform.

As has been mentioned previously, individual stabilizing ram valves may be operated independently to produce leveling of the platform on uneven underlying surfaces.

To disable the outrigger system and return it to a stowed position for travel as shown in FIG. 3, it is a simple matter to move the valves to their retracting position to retract rams 84, 86, 88, 90 to raise the foot pads on the stabilizing rams, and to retract rams 78a, 78b, 80a, 80b to retract the outrigger arms to their stowed position closely adjacent the platform.

Referring now to manipulator 12, it has a base, or mounting, unit 112 which is attached to platform 18 through a rotating connector 114. The rotating connector 114 allows the manipulator to be rotated freely in 360 degrees about a vertical axis relative to platform 18.

The manipulator illustrated has a pair of load arms 118, 120 pivotally mounted adjacent their rear ends to mounting unit 112 for raising and lowering by the vertical extension and retraction of a pair of rams 122 mounted on opposite sides of unit 112. The rod ends of rams 122 are pivotally connected to a rear end portion of arm 120. A third load arm 124 is pivotally connected adjacent its rear end to arms 118, 120 and extends outwardly therefrom with a load handling attachment, such as hook 126, at its outer end.

The pivotal interconnection between arms 120, 124 is indicated generally at 128 and the pivot connection between arms 118, 124 is indicated at 130.

A linkage plate 132 is pivotally connected at its opposite ends to arms 118, 120 adjacent their rear ends. A counterweight 134 of a selected mass is secured to the rear end of arm 118 for swinging therewith. A roller 136 is rotatably connected to arms 118 and linkage plate 132 where they are pivotally connected to each other. Roller 136 is confined to rolling movement substantially horizontally in a horizontally disposed slot 138, thus to control movement of the rear end of load arm 118. A roller, or pin, 140 connected to the rear end of arm 120 is confined to vertical movement only in a vertical slot 142 to guide the extension and retraction of rams 122 and the movement of the rear end of arm 120.

Mounted at the top ends of the rods of rams 122 is a substantially rigid connecting arm 146 having an inverted L-shape. The lower end of arm 146 is connected to roller 140. A second roller 140A is also received in and guided by slot 142 and is connected to an upper portion of arm 146. Rollers 140, 140A support arm 146 in the structure so that it may move vertically with the rod ends of rams 122, with its portion 146a held substantially horizontal throughout such movement.

A triangularly shaped plate connector 148 is pivotally connected at 128 to the adjacent ends of arms 120, 124 and a second triangular plate connector 150 is pivotally connected to the outer end of arm 124 at 152.

An elongate tension rod 154 extends substantially parallel to arm 120 and is connected at its opposite ends to horizontal portion 146a of arm 146 and plate connector 148. A second tension rod 156 extends substantially parallel to arm 124 and is connected at its opposite ends to connector plate 148 and connector plate 150.

Arms 118, 120 are constructed for longitudinal telescopic extension and retraction between an extended operating condition (as shown in FIGS. 1 and 2), and a retracted, stowed or transport condition (as shown in FIG. 3). Arms 118, 120 include elongate outer tubular sections 118a, 120a, and elongate inner sections 118b, 120b, slidably and telescopically received in the outer tubular sections. As illustrated in FIGS. 2 and 3, an elongate extensible, retractable ram 162 in arm 120 has its cylinder end connected to section 120a and its rod end connected to section 120b. Ram 162 is operable to extend and retract arm 120 as desired.

A pin-receiving hole 118c in section 118a is positioned to align with a similar hole adjacent the rear end of section 118b when the load arms are extended as in FIG. 2. A pin (not shown) is inserted in the aligned holes to secure sections 118a, 118b in the extended operating position shown in FIG. 2. Another pin-receiving hole 118d is adjacent the outer end of section 118b. When arm 118 is in its retracted position shown in FIG. 3, a pin inserted through holes 118c, 118d secures sections 118a, 118b in their compact stowed positions shown in FIG. 3.

Tension rod 154 also is composed of two longitudinally telescoping sections. These are an elongate tubular outer section 154a in which is slidably mounted an elongate inner section 154b. A releasable pin connector 154c serves to secure sections 154a, 154b in their extended position as shown in FIG. 2.

A simplified schematic diagram for a pressurized air operating system for the manipulator 12 is illustrated in FIG. 6. An air compressor 176 is operated by an AC motor 178. Battery 56 (previously described) is connected through a switch 180 and an inverter 182 to motor 178. The inverter converts the DC energy of battery 56 to AC power to run the motor and drive compressor 176. The compressor delivers pressurized air to an outfeed line 184. An auxiliary line 186 connected to line 184 and having a quick connect coupling 188 is provided to receive pressurized air from a source which might be on site in the location of the apparatus if it is desired not to use the battery powered compressor situated on the apparatus itself.

A first three position valve 192 having an actuator 194 coupled thereto is operable to provide pressurized air to ram 162 to telescopically extend and retract the manipulator load arms. A valve 196 having an actuator 198 coupled thereto is operable to produce controlled extension and retraction of rams 122.

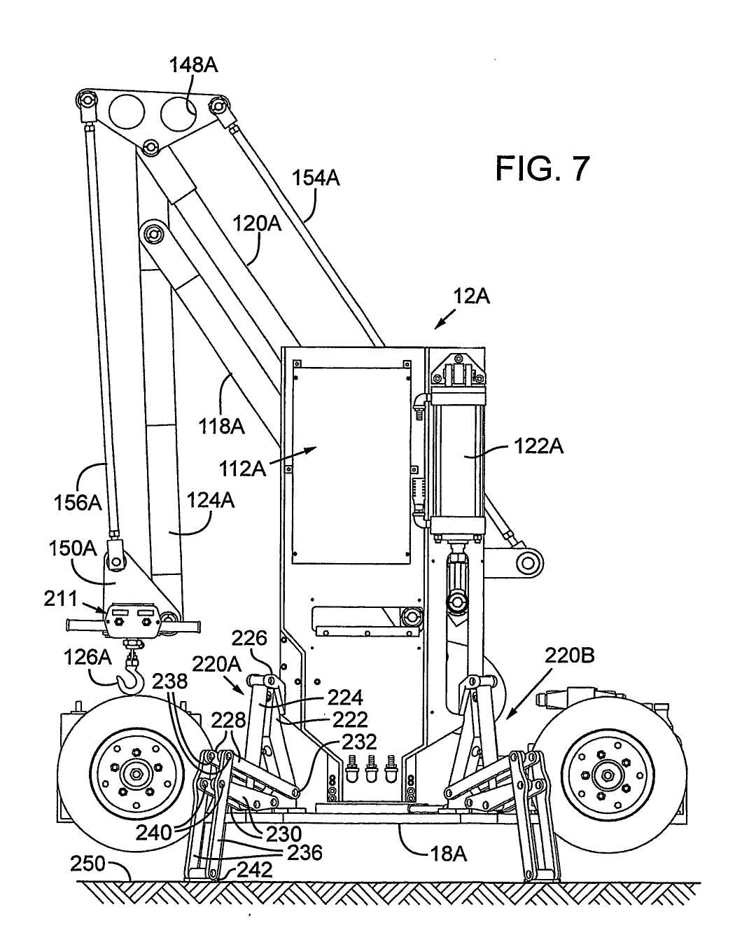

Valves 192, 196 are three position valves which are normally biased to a centered position in which operating fluid (air) is neither supplied to nor exhausted from their associated rams. Their associated actuators 194, 198 are operable to shift the valves to the positions as illustrated in FIG. 7 in which pressurized air would be supplied to the respective rams for extension, and another operating position in which pressurized air would be supplied and exhausted as needed to retract the rams.

The manipulator 12 may be any of a variety of styles of manipulators in which a load to be manipulated by the apparatus is connected to the outer end of load arm (such as arm 124, as through hook 126). The manipulator illustrated is merely one example of a number of different types and styles which may be used in the composite apparatus. In the illustrated device, pressurized air is supplied to rams 122 such that the actuation of the rams in conjunction with counterweight 134 provides a lifting force on the load which generally floats the load for manipulation by a worker.

Such devices, although without the extensible-retractable load arms 118, 120, and tension rod 154, are generally known. One such device is made by Coleman Equipment Company of Irvington, N.J., under their Model No. PML150DLA. The theory of operation of the manipulator is embodied in the relationship between the air logic circuit (not shown here), counterweighted mechanical arm, four bar linkage with slot guided rollers, air cylinders, rotating base unit and controls adjacent the load carrying end which operates these components. The result is generally a zero lifting weight, or minimal lifting weight, requirement for the operator and proportional feedback control to the worker. The lifting end of the mechanical load arm is floated over the load to be moved. The unloaded arm has a neutral balance as a result of the counterweight at the rear end of the load arms. Once attached to the load, a control balance switch (not shown) is actuated. The device then starts lifting at a preset adjustable rate. Lift is provided by the twin air cylinders 122 located at either side of the base unit. These cylinders apply vertical force to the rear end of the four bar linkage in the base unit through their connection to the rear end of arm 120 at the location of roller 140. When pressurized air is introduced to the system, the cylinders 122 contract providing a counter balance to the load weight. When the device fully supports the load, the operating switch is released. The device will sense the weight of the load and will put it into a substantially balanced floating condition. An air logic circuit (not shown) maintains a constant pressure in the cylinders and adjusts cylinder volume according to air-cylinder piston position as the load is moved within the work envelope. In this substantially balanced state, the load or part to be handled can be moved through the full work envelope by lightly pushing up or down, side-to-side, or in-and-out, on the load arm or on the load itself.

Various exemplary positions to which the load-carrying arm and hook may be moved are shown in solid and dashed outlines in FIG. 2. The four bar linkage and slotted rollers mechanism provide horizontal and vertical tracking for motion up and down. The double link mechanical arms preserves the orientation of the load throughout the work envelope. The rotating base unit pedestal provides 360 degree rotation. The device is constructed and its circuitry is such that it will do most of the work to support the load and will maintain the position at which the workman releases it.

To release the load, the operator presses an appropriate switch which will allow the pressure in the operating cylinders 122 to be released and the device will return to an empty balance position at which time the load will be lowered to a support surface and may be released.

As mentioned previously, the primary manipulator used may be a commercially available unit. However, such units as now constructed generally do not have telescopically extensible-retractable load arms as described herein for arms 118, 120 and tension rod 154. Such prior devices, with fixed length load arms, would have a constant load arm length as shown in dashed outline at 200 in FIG. 2 in their stowed position. Such configuration would be to too tall to conveniently move in many environments, such as, for example only, in mines, building construction, finished buildings, and maintenance activities. To provide apparatus which may be conveniently moved in such environments, the present device has been modified with the extensible-retractable load arms 118, 120 and tension rod 154 as previously described. When the arms are extended as illustrated in FIGS. 1 and 2, they provide the full range of operation for the apparatus and have a rather wide envelope of movement for manipulating a load. When the load arms 118, 120 and tension rod 154 are retracted and the apparatus is returned to its most compact position as illustrated in FIG. 3, the overall size of the apparatus is reduced to an extent that it conveniently may be moved through desired working environments.

In operation, the apparatus initially would have the configuration illustrated in FIG. 3 and be ready for movement to a work site. The load arms and outriggers are retracted to stowed positions generally within the confines of the horizontal footprint of base 14. The battery, compressor, pumps, valves, etc., are all mounted on base 14 in housing compartments 204, 206, such that the apparatus is totally self-contained and may be moved as needed. An operator actuating various control mechanism, such as through a pigtail connected set of switches, or other control mechanism, actuates the drive and steering mechanism for the base such that motor 24 turns at least one of the ground engaging wheels to drive the apparatus to the work locale, while steering via operation of ram 32.

After the apparatus has been driven under its own power to the desired work location the outriggers are extended laterally by action of rams 78a, 78b, 80a, 80b, and their foot pads lowered to engage the support surface by actuation of rams 84, 86, 88, 90. Then load arms 118, 120 and tension rod 154 are telescopically extended to their full working length by operation of ram 162 and previously discussed pins are inserted to secure the arms and tension rod in their extended positions.

A load as indicated at 210 to be manipulated is connected to the outer end of the load arms, as by tongs 212 or hook 126, and operation of the control circuit for rams 122 ensues to place a lifting force on the load such that it is floated into a position where it may be moved either up or down, toward or away from base unit 112, or rotated around the central pivot connection 114. The load is generally balanced in its lifted position by the circuitry for the manipulator such that workman 213 needs only to exert a small lifting, lowering, or lateral moving force on the load or the outer ends of the load arms to manipulate the load as he wishes.

After the load has been manipulated as desired it may be set back down by release of pressure in rams 122. The pins may be removed from the load arms 118, 120 and tension rod 154, and these arms and rod then may be retracted by retraction of ram 162 to their stored transport position as shown in FIG. 3. The outriggers are retracted and returned to their stowed position closely adjacent platform 18. The apparatus then may be moved under its own power to another selected operating position or region.

As an example of the apparatus thus described, the mobile platform 14 contains, or carries thereon, substantially all of the operating equipment for the device including pumps, compressors, motors, batteries, valves, etc. The four wheels may include 16 inch (41 cm) diameter foam-filled, hard rubber tires mounted at the four corners of platform 18. Multiple 12 volt DC batteries are appropriately interconnected to provide a 24 volt operating system to power the hydraulic and pneumatic portions of the system. The mobile platform may be approximately 65 inches (165 cm) long with a width of approximately 32 inches (81 cm).

The outrigger system, having four hydraulically telescoping outriggers with two each mounted on the front and rear of the mobile platform, are extendible to provide a stabilizing base of at least 48 inches (122 cm) by 48 inches (122 cm). The leveling cylinders provide sufficient extension that they can produce leveling for plus or minus six inches (15 cm) of support surface inclination.

The manipulator in the illustrated embodiment and, as previously mentioned, may be a Coleman Model PML150DLA which is modified for this application. The arms 118, 120 have been modified to telescope under the operation of their included ram 162 from a stored or travel length of approximately 37.5 inches (95 cm) to an operational length of 73 inches (185 cm). This modification of the prior manipulator results in a substantially reduced height stowed/traveling condition for the manipulator as illustrated in FIG. 3. The stored configuration of a form of the modified apparatus has a height less than 100 inches (254 cm) and a width less than 50 inches (127 cm), and more preferably a height less than 80 inches (203 cm) and width less than 45 inches (114 cm).

The operational envelope for the manipulator hook is described by an imaginary cylinder with an inner radius of 26.5 inches (67 cm), an outer radius of 90.5 inches (230 cm), a base point of 25 inches (64 cm) from the support surface and a ceiling of 86.5 inches (220 cm). This equates to a 64 inch (163 cm) horizontal by 61 inch (155 cm) vertical arm reach envelope.

The multiple link mechanism for the load arms allows a fixed gripping/picking attachment to maintain a specific orientation throughout operation. Further this allows the device to perform mailbox-type insertions of materials and equipment into areas which would not be accessible from above using traditional overhead lifting equipment. The lift capacity of the apparatus in this exemplary form is approximately 300 pounds and has a low center of gravity.

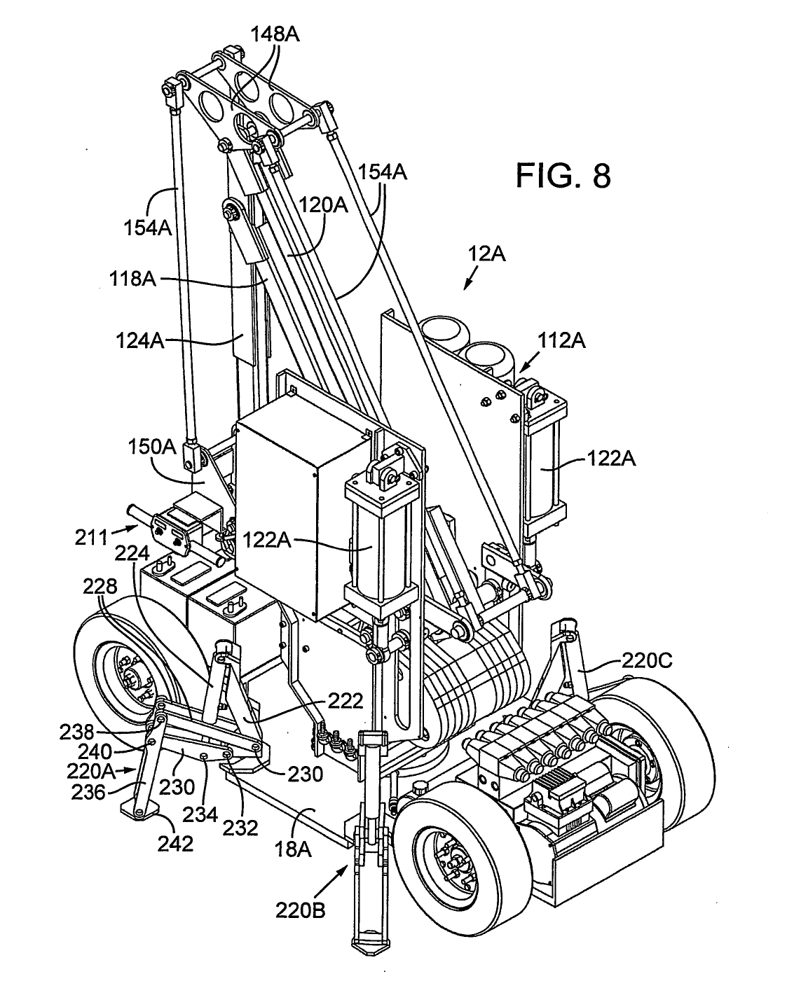

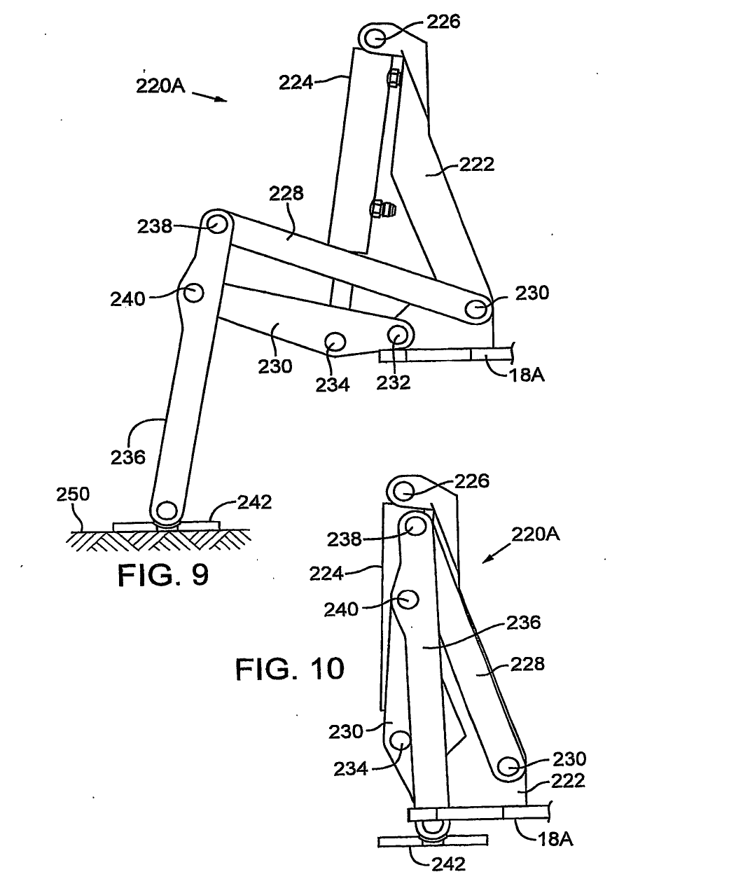

FIGS. 7-11 illustrate apparatus according to a second embodiment. The apparatus generally is similar to that previously described. A wheel mounted load manipulator 12A is illustrated mounted on a support platform 18A.

The load manipulator 12A includes a pair of load arms 118A, 120A, pivotally mounted adjacent their rear ends to mounting unit 112A. A pair of vertically disposed extension and retraction rams 122A are mounted on opposite sides of unit 112A. Although rams 122A are illustrated with their rod ends directed downwardly (as opposed to the upwardly directed rod ends of previously described rams 122) they are operatively connected to arms 118A, 120A as previously described to produce raising and lowering of arms 118A, 120A. A third load arm 124A is pivotally connected adjacent its rear end to arms 118A, 120A and extends outwardly, or downwardly, therefrom. A load handling attachment, such as hook 126A, is connected to the outer end of arm 124A. A manually grippable handle and control unit 211 is mounted at the outer end of arm 124A adjacent hook 126A. The handle and control unit 211 may be grasped by a workman in a position as illustrated in FIG. 1 to produce vertical and horizontal movement of a load supported by the hook end of the apparatus.

A triangularly shaped plate connector 148A is pivotally connected to the adjacent ends of arms 120A, 124A. The outer end of arm 118A is pivotally connected to arm 124A in a region spaced from the connection with arm 120A. A second triangular plate connector 150A is pivotally connected to the outer end of arm 124A. A pair of elongate tension rods 154A, 156A extend substantially parallel to arms 120A and 124A, respectively, and are connected to plate connectors 148A, 150A as illustrated here and as previously described for the prior embodiment. In this embodiment, arms 118A, 120A, and rod 154A are not telescopically extensible as described in the prior embodiment.

A pressurized air operating system for manipulator 12A would be somewhat similar to that illustrated in FIG. 6. However, for this second embodiment there would not be an elongate ram 162, as in the previously described embodiment, for extending and retracting the load arms and the control circuitry required for such telescoping arm.

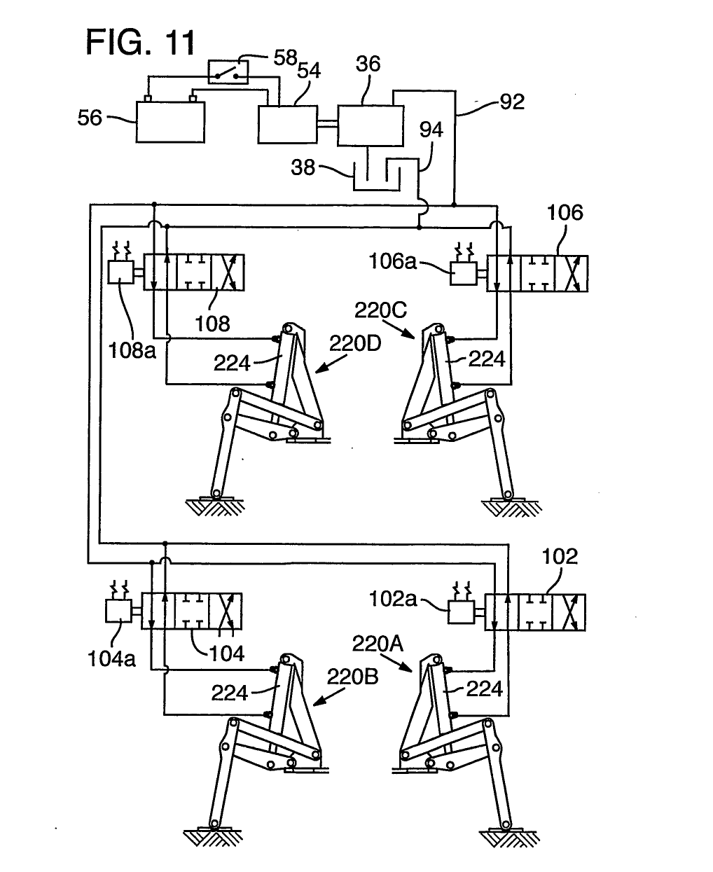

Mounted at the four corners of support platform 18A, adjacent the ground engaging wheels of the device, are four outriggers 220A, 220B, 220C, 220D. Due to the orientation of drawings on this embodiment outrigger 220D is illustrated only schematically in FIG. 11, but it should be understood that its construction is similar to those shown. Since each of the outriggers is similarly constructed only one will be described in detail.

Referring to FIGS. 7, 9, and 10, an outrigger includes an elongate upright support member 222 which is rigidly secured to support platform 18A and projects upwardly therefrom. The upper end of an elongate extensible-contractible ram 224 is pivotally connected at 226 to the upper end of support member 222.

The outrigger mechanism comprises a multiple bar linkage including a pair of parallel, laterally spaced link bars 228 pivotally connected adjacent an inner set of their ends at 230 to a lower end portion of support 222. A second pair of parallel, laterally spaced linkage bars 230 spaced below bars 228 are pivotally connected at 232 to a lower end portion of support 222 in a region spaced from pivot 230. The lower end of ram 224 is pivotally connected at 234 to an intermediate portion of each of linkage bars 230.

An elongate pair of parallel, laterally spaced linkage bars 236 are pivotally connected at their upper set of ends at 238 adjacent the outer ends of linkage bars 228. Intermediate portions of linkage bars 236 are pivotally connected at 240 to the outer ends of linkage bars 230. Pivots 238 and 240 are somewhat spaced apart longitudinally of bars 236. A foot pad, or support pad, 242 is pivotally connected to the lower ends of linkage bars 236.

Describing operation of an outrigger as described, and referring first to FIG. 10, when ram 224 is retracted the linkage bars, or arms, assume a contracted, or stowed, compact configuration as illustrated in FIG. 10. In this position they lie closely within the footprint of the load handling apparatus and support pad 242 is held closely adjacent support plate 18A.

Upon extension of ram 224 the outrigger moves toward the position illustrated in FIGS. 7-9 with the bars, or arms, swinging outwardly and away from support platform 18A and support pad 242 moving downwardly. Continued extension of the ram causes the support pad to engage an underlying support surface, such as ground 250 illustrated in FIG. 7. The outriggers may be so extended that they actually lift the wheels of the apparatus off the ground as illustrated in FIG. 7 such that the apparatus is firmly supported for operation. Each outrigger may be independently extended and retracted to provide leveling of the apparatus on an uneven underlying surface.

Referring to FIG. 11, a simplified operating schematic diagram of a hydraulic circuit for operating the outriggers is illustrated.

Pressurized hydraulic fluid for operating the outrigger system may be provided by a system similar to that previously described in regard to FIG. 5 of the prior embodiment. Thus pump 36 driven by motor 54 and energized by battery 56 through a switch 58 draws operating fluid from a reservoir 38. In the system illustrated in FIG. 11, the pump delivers fluid under pressure to an outfeed line 92 and fluid is returned to the reservoir 38 through a return line 94. Valves 102, 104, 106, 108 are interposed in the hydraulic circuit between the pump 36 and respective ones of the rams 224 for outrigger, 220A, 220B, 220C, 220D. Explaining further, valve 102 is associated with the ram for outrigger 220A, valve 104 with the ram for outrigger 220B, valve 106 with the ram for outrigger 220C, and valve 108 with the ram outrigger 220D.

All of the valves may be substantially the same, in that they are three position valves having a central position to which the valve is normally biased which shuts off fluid flow to and from its associated ram. Each valve also is shiftable to a second position in which pressurized fluid is supplied to a first end of its associated ram and fluid is exhausted from the second end of the ram to provide extension of the ram, and a third position in which fluid is supplied to the second end of the ram and exhausted from the first end to produce retraction of the ram.

Each valve has an associated actuator connected thereto noted 102a, 104a, 106a, and 108a, respectively, for producing selected shifting of the valve to an appropriate position for extending, retracting, or holding its associated ram in a selected position. As has been mentioned previously, individual stabilizing ram valves may be operated independently to produce leveling of the platform on uneven underlying surfaces.

Operation of the apparatus of the second embodiment illustrated in FIGS. 7-12 is substantially similar to that previously described in regard to the prior embodiment.

As in the prior embodiment, the size of the apparatus and the operational envelope in which it operates can be important. With the structure disclosed in FIGS. 7-11 the stored configuration of the apparatus has a height no greater than 78 inches (198 cm) and a width no greater than 32 inches (81 cm). The operational envelope in which the manipulator hook, or arm ends, is described by an imaginary cylinder with an inner radius of 24 inches (61 cm), an outer radius of 75.5 inches (192 cm), a base point of 16.5 inches (42 cm) from the support surface and a ceiling of 63.5 inches (161 cm). This equates to a 51 inch (130 cm) horizontal by 46 inch (117 cm) vertical arm reach envelope. The outriggers of the embodiment illustrated in FIGS. 7-10 preferably are extendable to provide a stabilizing base of at least 38 inches (97 cm) long by 44 inches (112 cm) wide.

The apparatus disclosed herein provides an integrated lifting system incorporating a manipulator, self-propelled platform, leveling and stabilizing outriggers, and self-contained pressurized fluid and control systems. The resulting mobile manipulator system can travel under its own power to a desired work location, deploy its outriggers, level the base unit, then may be operated through its self-contained fluid pressure systems, all under the control of a single operator. Thus it is capable of being conveniently moved to a needed operating location so that it will be relied upon by workmen rather than workmen attempting to lift, pull, or otherwise manipulate heavy loads which may produce workmen injury.

While an embodiment of the apparatus has been described and illustrated herein, it should be apparent to those skilled in the art that variations and modifications are possible without departing from spirit of the invention which is set out in the following claims.

1. Load handling apparatus comprising
a support platform,
a plurality of wheels connected to the platform for supporting the platform for movement over an underlying surface,
driving motor mechanism operatively connected to at least one of said wheels to produce movement of the platform, said driving motor mechanism comprising a reversible fluid actuated driving motor supported on said platform operatively connected to a wheel for driving said wheel selectively in forward and reverse directions, a source of pressurized fluid on said platform, and valve mechanism operatively interposed between said source of pressurized fluid and said driving motor to control routing of pressurized fluid from said source to said driving motor,
stabilizing mechanism connected to the platform operable to support and stabilize said platform when in a selected operating position, and
load manipulating mechanism mounted on said platform and operable to lift a load adjacent the platform.

2. The apparatus of claim 1, wherein said driving motor mechanism comprises a plurality of said driving motors, with each said driving motor operatively connected to a selected one of said wheels and said valve mechanism is operable to produce coordinated operation of said wheels.

3. The apparatus of claim 1, wherein said stabilizing mechanism comprises a pair of extensible-retractable outriggers mounted on said platform for shifting laterally of said platform between retracted positions closely adjacent said platform and extended positions spaced outwardly from opposite sides of said platform.

4. The apparatus of claim 3, wherein said outriggers further comprise vertically disposed fluid actuated rams having downwardly directed rods with support pads operatively connected to the lower ends thereof for engaging an underlying surface, and valve mechanism for selectively routing pressurized fluid from said source of pressurized fluid to said rams to lower and raise said pads.

5. The apparatus of claim 3, which further comprises fluid actuated outrigger operating motor mechanism operable to produce extension and retraction of said outriggers.

6. The apparatus of claim 5, wherein said outrigger operating motor mechanism comprises an elongate horizontally disposed ram.

7. The apparatus of claim 4, wherein said outriggers are configured to be disposed closely adjacent the horizontal footprint of the support platform when retracted.

8. The apparatus of claim 1, wherein said stabilizing mechanism comprises a pair of extensible-retractable outriggers mounted on said platform, an outrigger comprising a multi-bar linkage having a support pad thereon for engaging an underlying surface and a fluid actuated ram operatively connected to said linkage for shifting said linkage between a retracted position with the support pad adjacent the support platform and an extended position spaced outwardly from and below the elevation of said platform.

9. The apparatus of claim 8, wherein said multi-bar linkage comprises a first elongate bar having said support pad connected to a lower end portion thereof, second and third elongate bars pivotally connected adjacent outer ends of said second and third bars to spaced apart locations on said first bar above said support pad and pivotally connected adjacent inner ends of said second and third bars at spaced locations on said support platform.

10. The apparatus of claim 9, wherein one end of said ram is operatively connected to one of said second and third arms and the opposite end of said ram is operatively connected to a member secured to said platform such that extension of the ram moves said multi-bar linkage to its extended position and contraction of the ram moves said multi-bar linkage to its retracted position.

11. The apparatus of claim 8, wherein said outriggers are mounted on opposite sides of said support platform.

12. The apparatus of claim 1, wherein said load manipulating mechanism comprises a load arm which is configured to be retractable to a stowed position for transport and disposed generally fully within the horizontal footprint of the support platform.

13. The apparatus of claim 1, wherein said load manipulating mechanism is actuated by fluid under pressure, and which further comprises valve mechanism for selectively routing fluid under pressure to said manipulating mechanism for controlling operation of said manipulating mechanism.

14. The apparatus of claim 13, wherein said load manipulating mechanism is air operated and said apparatus further comprises a source of pressurized air on said platform.

15. The apparatus of claim 14, wherein said source of pressurized air comprises a compressor and compressor motor operatively connected to the compressor.

16. The apparatus of claim 15, wherein said compressor motor is electrically operated and which further comprises a source of electrical energy mounted on said platform for actuating said compressor motor.

17. The apparatus of claim 1, wherein said source of fluid pressure comprises a hydraulic pump and an electrically operated pump motor operatively connected thereto, and which further comprises a source of electrical energy mounted on said platform for actuating said pump motor.

18. The apparatus of claim 1, wherein said load manipulating mechanism comprises a load carrying arm mounted for vertical and horizontal movement relative to said platform.

19. The apparatus of claim 18, which is configured to have total outer dimensions when said manipulating mechanism is retracted which are no greater than 100 inches (254 cm) high and 50 inches (127 cm) wide.

20. The apparatus of claim 18, which is configured to have total outer dimensions when said manipulating mechanism is retracted which are no greater than 80 inches (203 cm) high and 45 inches (114 cm) wide.

21. The apparatus of claim 18, wherein said stabilizing mechanism comprises a pair of extensible-retractable outriggers mounted on said platform for shifting laterally of said platform between retracted positions closely adjacent said platform and extended positions spaced outwardly from opposite sides of said platform, and said apparatus is configured to have total outer dimensions when said manipulating mechanism and outriggers are retracted which are no greater than 78 inches (198 cm) high and 32 inches (81 cm) wide.

22. The apparatus of claim 1, wherein said load manipulating mechanism comprises a first elongate load arm which is telescopically extensible and retractable between a retracted condition for transport and an extended condition for load handling operation.

23. The apparatus of claim 22, wherein said load manipulating mechanism comprises a second elongate load arm which is telescopically extensible and retractable between a retracted condition for transport and an extended condition for load handling operation, and connecting linkage which maintains said first and second load arms substantially parallel to each other during operation.

24. The apparatus of claim 23, which further comprises extension mechanism operable to extend and retract said first and second load arms and releasable securing mechanism for locking said first and second arms in their extended conditions.

25. Load handling apparatus comprising
a support platform,
a plurality of wheels connected to the platform for supporting the platform for movement over an underlying surface,
driving motor mechanism operatively connected to at least one of said wheels to produce movement of the platform,
stabilizing mechanism connected to the platform operable to support and stabilize said platform when in a selected operating position, and
load manipulating mechanism mounted on said platform comprising first and second elongate load arms, each of which is telescopically extensible and retractable between a retracted condition for transport and an extended condition for load handling operation and connecting linkage which maintains said first and second load arms substantially parallel to each other during operation.

26. The apparatus of claim 21, which further comprises extension mechanism operable to extend and retract said first and second load arms and releasable securing mechanism for locking said first and second arms in their extended conditions.

27. The apparatus of claim 25, wherein said stabilizing mechanism comprises a pair of extensible-retractable outriggers mounted on said platform, an outrigger comprising a multi-bar linkage having a support pad thereon for engaging an underlying surface and a fluid actuated ram operatively connected to said linkage for shifting said linkage between a retracted position with the support pad adjacent the support platform and an extended position spaced outwardly from and below the elevation of said platform.

28. The apparatus of claim 27, wherein said multi-bar linkage comprises a first elongate bar having said support pad connected to a lower end portion thereof, second and third elongate bars pivotally connected adjacent outer ends of said second and third bars to spaced apart locations on said first bar above said support pad and pivotally connected adjacent inner ends of said second and third bars at spaced locations on said support platform.

29. The apparatus of claim 28, wherein one end of said ram is operatively connect to one of said second and third arms and the opposite end of said ram is operatively connected to a member secured to said platform such that extension of the ram moves said multi-bar linkage to its extended position and contraction of the ram moves said multi-bar linkage to its retracted position.

30. The apparatus of claim 27, wherein said outriggers are mounted on opposite sides of said support platform.
